(19) United States
(12) Patent Application Publication
(10) Pub. No.: US 2007/0143981 A1
(43) Pub. Date: Jun. 28, 2007

(54) Device for fixing a chute to a powder-product-feed hopper of an electrolytic cell

(75) Inventor: Bernard Bourges, Avelin (FR)

Correspondence Address: BANNER & WITCOFF, LTD., TEN SOUTH WACKER DRIVE, SUITE 3000, CHICAGO, IL, 60606, US

(73) Assignee: E.C.L., Ronchin (FR)

(21) Appl. No.: 10/598,772

(22) PCT Filed: Mar. 8, 2005
(86) PCT No.: PCT/FR05/00551

§ 371 Date: Sep. 11, 2006

(30) Foreign Application Priority Data
Mar. 11, 2004 (FR) 0402538

(51) Int. Cl. B23P 19/00; B21D 39/03

(52) U.S. Cl. 29/426.1; 29/428

(57) ABSTRACT

The invention relates to a device for fixing a chute to a powder-product-feed hopper of an electrolytic cell. According to the invention, the chute (4) is fixed to the base of a hopper (3) or a similar powder-product-feed apparatus. The hopper (3) comprises chute-support and fixing means consisting of at least one hook element (7) having an essentially-horizontal support area which is solidly connected to the hopper, while the body of the chute (4) is provided with at least one hook (9) which is articulated around a horizontal axis and which is intended to be hooked onto the hook element (7) of the hopper. The simple structure of the inventive device greatly improves on existing technology, enabling the rapid mounting and removal of powder-product-feed chutes in electrolytic cells during the operation thereof, in full safety for the operator.

This invention relates to fixing a powder product supply chute onto a hopper or a similar device arranged above an electrolytic pot, and particularly an electrolytic pot for aluminum production.

Electrolytic pots must be supplied with powder products composed of alumina, aluminum fluoride or ground bath, for electrolytic pots used to make aluminum.

Hoppers that are distributed along the pot are fixed to a superstructure arranged above the pot and the chutes are fixed to the hoppers. The chutes are fixed to the hoppers by screws. The result is that the operator needs to enter the tank to perform any assembly or disassembly operation. Electrolytic pots, particularly for aluminum production, work continuously during very long periods, and the problem of replacing a chute during operation of the pot arises.

Therefore, a purpose of the invention is to provide a device solving this technical problem, by which a chute can be replaced from an area located outside the pot, in a safe manner for the operator.

### DESCRIPTION OF THE INVENTION

A purpose of the invention is a device for attachment of a chute onto an exit opening from a hopper conveying powder products into an electrolytic pot, the chute comprising a body and a tube, characterized in that the hopper comprises at least one element for attaching the chute, fixed to the hopper, and comprising a bearing area that is substantially horizontal during use, and in that the body of the chute comprises at least one attachment hook articulated around a substantially horizontal axis during use, and designed to engage onto the attachment element of the hopper or one of the attachment elements of the hopper.

Since the attachment is made by latching rather than by screwing, a chute can be disassembled or reassembled from a distance by lifting the chute and actuating its attachment hook(s).

According to one embodiment the attachment element or each attachment element of the hopper is located radially at a distance from the exit opening of the hopper, the articulated attachment hook or each attachment hook of the chute being orientated outwards and being intended to engage from the inside towards the outside onto the attachment element of the hopper, or one of the attachment elements of the hopper.

The attachment hooks thus have an attachment position in which the chute is fixed to the hopper and supported by it, and a detachment (or disengagement) position in which the chute may be withdrawn freely.

According to one simple embodiment of this device, the attachment element of the hopper or each attachment element of the hopper comprises a tab of general vertical orientation during use with an opening forming an open or closed ring for engagement of an attachment hook.

According to one aspect of the invention, the hopper is not necessarily equipped with tabs forming rings, but an annular horizontal rim provided with a vertical rim, or a peripheral attachment ring. In particular, the attachment element may be a single element and may comprise a ring or an annular collar, with its orientation substantially horizontal during use, fixed to the hopper, located at a specific distance from the exit opening of the hopper and comprising a rim facing upwards to attach the attachment hook(s).

According to one advantageous embodiment of the invention, the attachment hook of the chute or each attachment hook of the chute comprises a so-called “upper” part located above the axis of articulation during use, forming the hook itself, and a so-called “lower” part located below the axis of articulation during use and comprising a ramp shaped surface which, being on the opposite side to the open side of the hook or each hook, will tip the hook towards a so-called detachment position which enables it to be separated from an attachment element of the hopper. An instrument can thus be used from a distance to act on the ramp and make an attachment hook tip by applying a cam effect.

The distribution of mass between the upper part and the lower part of the articulated hook (or each hook), in other words between the parts of the articulated hook (or each hook) located above and underneath the axis of articulation during use, is preferably such that it maintains the hook (or each hook) in a so-called attachment position so that it can be fixed onto the hopper. This characteristic has the advantage that when an action on the ramp of a hook is no longer applied, it will naturally be in its attachment position due to the effect of gravity.

The invention also relates to an accessory, characterized in that it comprises means for the vertical displacement of the chute and means for actuating the attachment hook or each attachment hook.

Another purpose of the invention is to provide a method of assembling and disassembling a chute on a hopper characterized in that it includes creating a vertical displacement of the chute with respect to the hopper to bring the hook(s) into a position in which it is or they are above the attachment element(s), followed by actuation of the attachment hook(s) to detach it (them), or actuation of the attachment hook(s) to attach it (them), depending on whether the purpose is to remove or to install the chute.

Another purpose of the invention is to provide an electrolytic cell equipped with hoppers or similar devices and/or chutes equipped with the attachment device according to the invention, for its powder product supply.

Another purpose of the invention is to provide a hopper for supplying an electrolytic pot with powder products, comprising at least one chute attachment element according to the invention.

Another purpose of the invention is to provide a chute to supply an electrolytic pot with powder products, to be fixed onto a hopper or similar device and comprising at least one attachment hook articulated according to the invention.

The invention is described in detail below with reference to the appended figures that illustrate one embodiment of this device and one embodiment of an accessory for use of the device, as a non-limitative example.

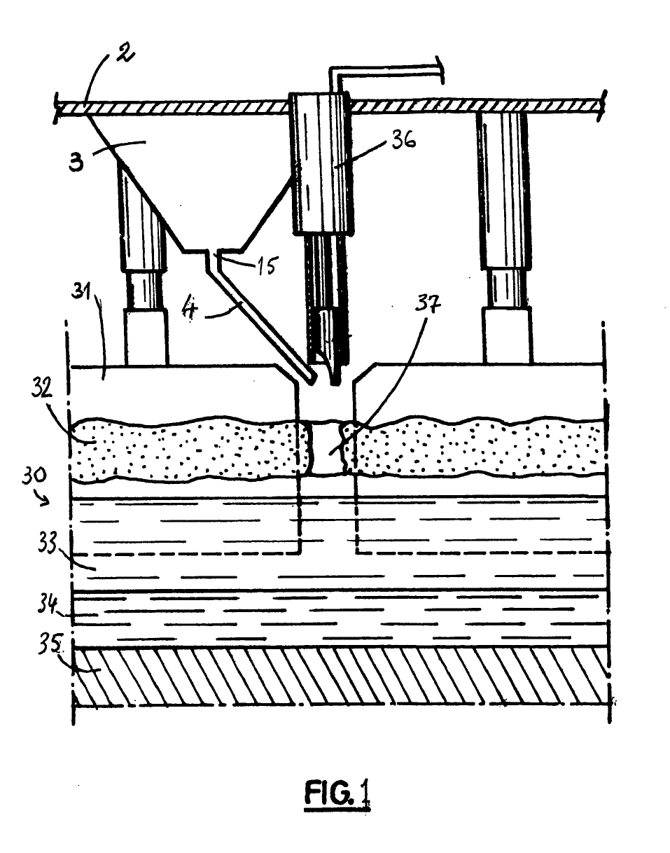

FIG. 1 shows a partial inner view of a typical electrolytic cell designed for production of aluminum by fused bath electrolysis, seen in a vertical section.

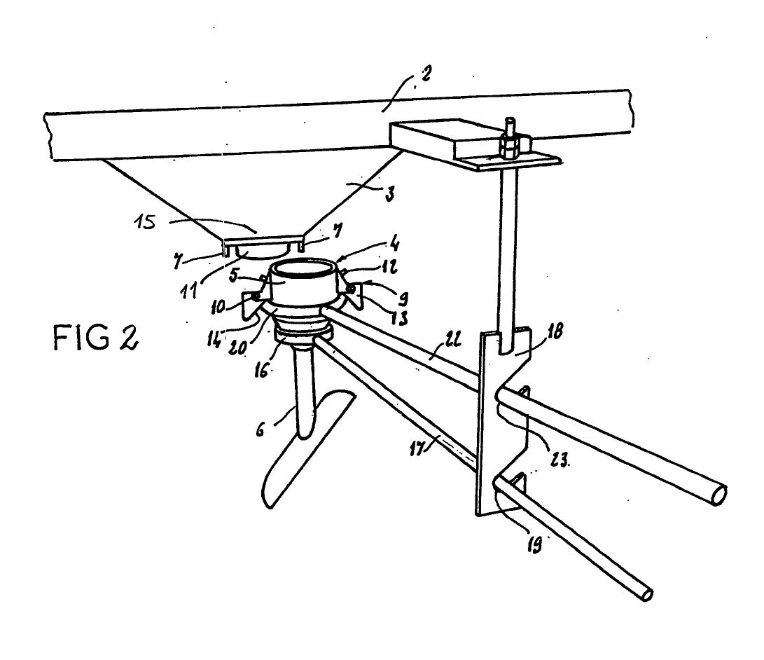

FIG. 2 shows a perspective view of a chute being fixed to a hopper according to an embodiment of the invention.

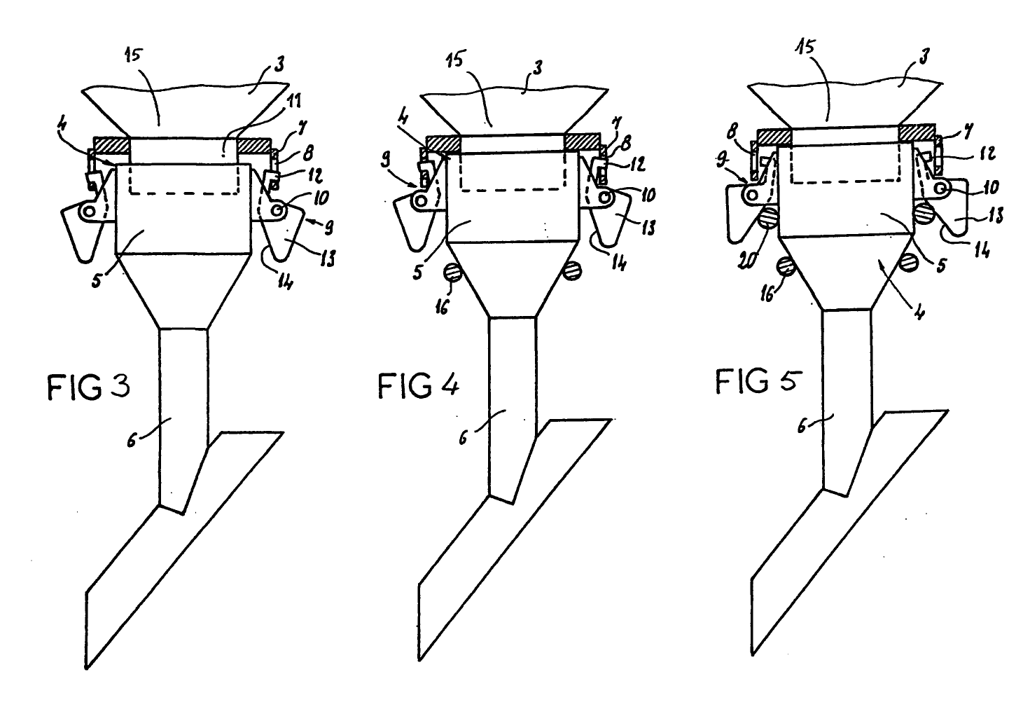

FIGS. 3 to 5 show three sectional views showing a chute in a fixed position on a hopper, and in two positions during assembly or disassembly, according to an embodiment of the invention.

As illustrated in FIG. 1, an electrolytic cell for production of aluminum by fused bath electrolysis, in other words electrolysis of molten salt, comprises a pot 30, anodes 31 and at least one powder materials supply hopper 3. The hopper 3 is provided with a chute 4 fixed onto an exit opening 15 located at the bottom of the hopper. The hopper 3 is supported by a superstructure 2 located above the pot. The pot 30 comprises a cathode 35 on which the electrolyte bath 33 and a layer of liquid aluminum 34 are supported when the cell is in operation. An alumina and solidified bath layer 32 is usually formed above the bath and a crustbreaker 36 is usually provided to form an opening 37 in this layer through which powder products can be added through the chute 4.

According to the invention, the hopper 3 and the chute 4 may be fixed to each other by an attachment device that is chars fist in that the hopper 3 comprises at least one chute attachment element 7, fixed to the hopper and comprising a bearing area that is substantially horizontal during use (in other words substantially horizontal when the hopper is installed in the electrolytic cell), and second in that the body 5 of the chute 4 comprises at least one attachment hook 9 articulated about an axis of articulation that is substantially horizontal during use (in other words substantially horizontal when the chute is fixed to the hopper) and that will engage onto the attachment element 7 of the hopper.

The attachment element(s) 7 of the hopper is (are) also used to support the chute.

The device may have only one articulated attachment hook. In this case, the side diametrically opposite the body 5 of the chute 4 preferably comprises at least one fixed hook or means of attachment.

FIG. 2 shows a hopper 3 intended to receive powder products such as alumina, to which a chute 4 comprising a body 5, typically cylindrical in shape, will be fixed, together with a tube 6 to guide powder products into the electrolytic pot.

The exit opening 15 of the hopper is advantageously provided with a mouth 11, typically cylindrical in shape, around which the body 5 of the chute 4 can be fitted.

In the embodiment of the invention illustrated in FIGS. 2-5, the hopper 3 is equipped with two substantially vertical metal tabs 7, pointing downwards, arranged opposite each other, each comprising an opening 8, thus forming a ring. The body 5 of the chute, which is typically generally circular in shape, comprises two diametrically opposite hooks 9 each pivoting about an axis 10 (typically a hinge pin) that is substantially horizontal during use. Each hook 9 has an upper part 12 forming the hook itself, and a lower part 13 that includes a ramp 14 on the inner side. The distribution of mass between the upper part 12 and the lower part 13 is preferably such that under the effect of gravity, the hook of the upper part 12 tends to pivot outwards. The spacing between the two tabs 7 of the hopper 3 is such that the hooks can be engaged between the two tabs 7 and penetrate into the openings 8 in the tabs from the inside towards the outside.

The upper part 12 of the articulated hook or each hook 9 may be profiled to form a ramp 14 enabling automatic pivoting of the hook(s) as it is (they are) brought upwards into contact with the attachment element(s) 7 of the hopper.

FIG. 3 shows the device in its position during use. In this case the chute 4 is fixed to the hopper 3 by two hooks 9 engaged in the rings 7,8 of the hopper.

The chute is advantageously put into position and removed using an accessory shown in a perspective view in FIG. 2 and which includes means of vertical displacement of the chute 4 and means of actuation of the attachment hook or each attachment hook 9.

According to one embodiment of this accessory, the vertical displacement means comprise an open ring 16 that will engage around the chute 4 and will apply upward pressure on the body 5 of the chute to be able to lift it and which is installed at the end of an actuation device such as a rod 17. The free end of the actuation device 17 is preferably associated with a coating or a thermal and/or electrical insulating element (not illustrated).

The means of actuation of the hook or each hook comprise an open ring 20 that will engage around the body 5 of the chute 4 and will press the ramp 14 of the hook or each hook 9 to tip it towards a position that separates it from the attachment element 7 of the hopper, in other words to tip the top part of each hook inwards, and which is installed at the end of an actuation device such as a rod 22. The free end of the actuation device 22 is preferably associated with a coating or a thermal and/or electrical insulating element (not illustrated).

Advantageously, the accessory according to the invention also comprises a fixed or a removable rack 18 that will form a bearing point for each actuation device 17, 22 of an open ring 16, 20. This rack is typically arranged on the superstructure 2 of the electrolytic cell between the area in which the operator is located and the chute. Thus, to activate the rings 16, 20, the rack 18 comprises at least one notch 19, 23 that will form a bearing point for one or for each actuation device 17, 22 for an open ring 16, 20. The actuation device(s) 17, 22 may be engaged in the notches and may be actuated from their free end(s) by an operator.

From a practical point of view, starting from the situation in FIG. 3 in which the chute is fixed to the 15 hopper, the chute is disassembled as follows.

In the embodiment shown in FIG. 4, the lifting ring 16 is moved upwards using the rod 17, so that the hooks 9 are lifted with respect to the openings 8 of the tabs 7, and can pivot inwards. When the chute 4 is in this vertical position, the actuation ring 20 is lifted as shown in FIG. 5, this ring presses against the ramps 14 of the hooks 9 to make the top part of the hooks pivot inwards, and thus release the hooks from the tabs 7. The chute is then lowered using the open ring 16, while keeping the hooks close together, until the hooks are below the tabs 7.

It is also possible, in an embodiment of the invention to use only the actuation ring 20 to perform all these operations to disassemble the chute 4.

The chute 4 is put into place using the same procedure in the reverse order. The chute is lifted using the ring 16, and the hooks are tipped inward under the action of the ring 20 that acts on the ramps 14 by a cam effect. When the hooks are facing the openings 8 of the tabs 7, the actuation ring 20 is moved downward enabling the hooks to tip outward. The lifting ring 16 is then lowered such that the hooks can bear on the lower part of the openings 8 of the tabs 7.

It is also possible in an embodiment to use only the actuation ring 16 to put the chute 4 into place when the top part 12 of the articulated hook or each articulated hook 9 is profiled to form a ramp enabling automatic pivoting by a cam effect.

As is clear from the above, the invention very much improves existing techniques, by supplying a device with a simple structure, enabling fast assembly and disassembly of chutes for conveying powder products into an electrolytic pot during operation of the pot, in a safe manner for the operator.

As is obvious, the invention is not restricted to the single embodiment of this device nor to the single accessory as described above as examples, and on the other hand it includes all variants.

1. A Device for attachment of a chute onto an exit opening of a hopper conveying powder products into an electrolytic pot, wherein:
the hopper comprises at least one chute attachment element, which is fixed to the hopper and which includes a bearing area that is substantially horizontal during use; and
the chute comprises a body and a tube, the body of the chute comprising at least one articulated attachment hook articulated about a substantially horizontal axis during use, and designed to engage onto at least one attachment element of the hopper.

2. The device according to claim 1, wherein the at least one attachment element of the hopper is located radially at a distance from the exit opening of the hopper, the at least one articulated attachment hook of the chute orientated outward and intended to engage from the inside toward the outside onto the at least one attachment element of the hopper.

3. The device according to claim 1, wherein the at least one attachment element of the hopper comprises a tab of general vertical orientation during use with an opening, forming an open or closed ring for engagement of the at least one attachment hook.

4. The device according to claim 1, wherein the at least one attachment element is a single element and comprises a ring or an annular collar, with its orientation substantially horizontal during use, fixed to the hopper, located at a specific distance from the exit opening of the hopper and comprising a rim facing upwards to attach the attachment hook(s).

5. The device according to claim 1, wherein the at least one attachment hook of the chute comprises an upper part located above the axis of articulation during use, forming the hook itself, and a lower part located below the axis of articulation during use and comprising a ramp shaped surface which, being on the opposite side to the open side of the hook, will tip the hook toward a detachment position, which enables it to be separated from the at least one attachment element of the hopper.

6. The device according to claim 5, wherein the upper part and the lower part of the hook have mass and wherein the distribution of mass between the upper part and the lower part of the hook, is such that it maintains the hook in an attachment position so that it can be fixed onto the hopper.

7. The device according to claim 5, wherein the upper part of the articulated hook is profiled to form a ramp enabling automatic pivoting of the hook as it is brought upwards into contact with the at least one attachment element of the hopper.

8. A hopper for conveying powder products into an electrolytic pot, onto which a chute is fixed, wherein the hopper comprises at least one attachment element fixed to the hopper, and including a bearing area that is substantially horizontal during use.

9. The hopper according to claim 8, wherein the at least one attachment element of the hopper is located radially at a distance from the exit opening of the hopper.

10. The hopper according to claim 9, wherein the at least one attachment element comprises a tab of general vertical direction during use with an opening forming an open or closed ring for engagement of an attachment hook.

11. The hopper according to claim 9, wherein the at least one attachment element is a single element and comprises a ring or an annular collar, with its orientation substantially horizontal during use, fixed to the hopper, located at a specific distance from the exit opening of the hopper and comprising a rim facing upwards to attach one or more attachment hooks.

12. A chute for conveying powder products into an electrolytic pot, to be fitted on a hopper comprising a body and a tube, wherein the body comprises at least one hook articulated about a substantially horizontal axis of articulation during use and designed to engage onto an attachment element of the hopper.

13. The chute according to claim 12, wherein the at least one articulated hook is orientated outward and will engage from the inside toward the outside onto an attachment element of the hopper.

14. The chute according to claim 13, wherein the at least one hook comprises an upper part located above the axis of articulation during use, forming the hook itself, and a lower part located below the axis of articulation during use and comprising a ramp shaped surface which, is located toward the opposite side to the open side of the hook and is configured to tip the hook toward a position that will enable it to be separated from the attachment element of the hopper.

15. The chute according to claim 14 wherein the distribution of mass between the upper part and the lower part of the hooks is such that it maintains the hooks in an attachment position so that it can be fixed onto a hopper.

16. The chute according to claim 14, wherein the upper part of the at least one hook is profiled to form a ramp enabling automatic pivoting of the at least one hook as they are it is brought upwards into contact with the attachment element of the hopper.

17. An accessory for assembly and disassembly of a chute onto a hopper, wherein the accessory comprises means to displace the chute vertically and means for actuating the one or more attachment hooks.

18. The accessory according to claim 17, wherein the vertical displacement means comprise an open ring intended to engage around the chute and will apply upward pressure on the body of the chute to be able to lift it, and which is configured to be installed at the end of an actuation device such as a rod.

19. The accessory according to claim 17, wherein the means for actuating the one or more attachment hooks comprises an open ring that is configured to engage around the body of the chute and will lean against a ramp of the at least one hook to tip it toward a position that enables it to be separated from an attachment element of the hopper, and which is installed at the end of an actuation device such as a rod.

20. The accessory according to claim 19, wherein the accessory comprises a fixed or a removable rack typically arranged on the superstructure of an electrolytic cell, the rack comprising at least one notch intended to form a bearing point for the actuation device of an open ring.

21. A method of assembling and disassembling a chute on a hopper for implementation of an attachment device, including (1) creating a vertical displacement of the chute with respect to the hopper to which brings one or more attachment hooks into a position in which they are above one or more attachment elements, followed by (2) actuating the one or more attachment hooks to detach the one or more attachment elements, or actuating the one or more attachment hook to attach the one or more attachment elements, depending on whether the purpose is to remove or to install the chute.

22. The method according to claim 21, wherein step 1 includes use of an accessory.

23. An electrolytic cell comprising:
a. at least one hopper comprising at least one attachment element fixed to the at least one hopper and a bearing area that is substantially horizontal during use; and
b. at least one chute, fixed onto a hopper to convey powder products to the cell, the chute comprising a body, a tube and at least one hook articulated about a substantially horizontal axis of articulation during use and designed to engage onto the at least one attachment element.
